(19) United States
(12) Patent Application Publication
(10) Pub. No.: US 2015/0008832 A1
(43) Pub. Date: Jan. 8, 2015

(54) LED light strings with remote controlling device for growing plants

(71) Applicant: Formolight Technologies, Inc., New Taipei City (TW)

(72) Inventor: Paul Chou, New Taipei City (TW)

(21) Appl. No.: 13/933,710

(22) Filed: Jul. 2, 2013

(51) Int. Cl. H05B 33/08

(52) U.S. Cl. CPC H05B 33/0842
USPC 315/161

(57) ABSTRACT

A LED lighting apparatus for growing plants includes a remote controlling device for sending wireless signals; and at least one lighting device each including a receiver and transmitter for receiving the wireless signals sent from the remote controlling device, a first power source electrically connected to the receiver and transmitter and being capable of supplying electricity to four downstream first LED groups connected in series, and a second power source electrically connected to the first power source via the first LED groups and being capable of supplying electricity to four downstream second LED groups connected in series.

### BACKGROUND OF THE INVENTION

1. Field of the Invention

The invention relates to LEDs (light-emitting diodes) and more particularly to a lighting apparatus comprising a remote controlling device such as laptop for sending a wireless control signal to two lighting devices each including a plurality of LED light groups connected in series for growing plants.

2. Description of Related Art

LEDs have many advantages including emitting more light per watt than incandescent light bulbs, emitting light of an intended color without using any color filters as typical lighting methods need, being very small, and being easily attached to printed circuit boards.

LEDs are widely used in applications such as aviation lighting, digital microscopes, automotive lighting, advertising, general lighting, and traffic signals.

However, LEDs for growing plants are not commercially successful due to many reasons.

Thus, the need for improvement still exists.

### SUMMARY OF THE INVENTION

It is therefore one object of the invention to provide a lighting apparatus comprising a remote controlling device for sending wireless signals; and at least one lighting device each including a receiver and transmitter for receiving the wireless signals sent from the remote controlling device, a first power source electrically connected to the receiver and transmitter and being capable of supplying electricity to four downstream first LED groups connected in series, and a second power source electrically connected to the first power source via the first LED groups and being capable of supplying electricity to four downstream second LED groups connected in series.

The above and other objects, features and advantages of the invention will become apparent from the following detailed description taken with the accompanying drawings.

### BRIEF DESCRIPTION OF THE DRAWINGS

FIG. 1 is a schematic illustration of a LED light assembly for growing plants according to the invention.

### DETAILED DESCRIPTION OF THE INVENTION

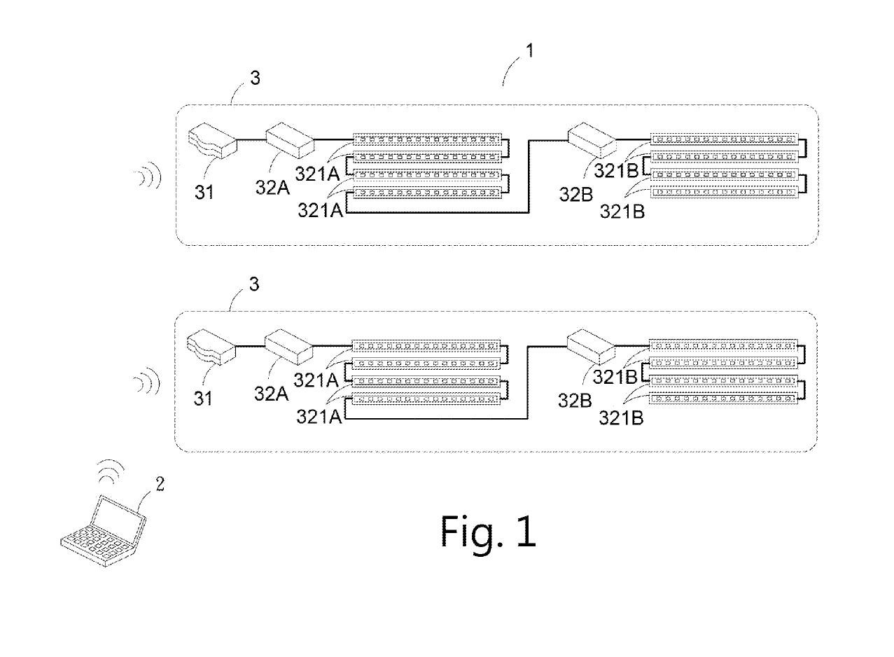

Referring to FIG. 1, a LED light assembly 1 for growing plants in accordance with the invention comprises the following components as discussed in detail below.

A remote controlling device 2 such as a laptop (as shown), a desk top computer, a tablet, or a smartphone is provided.

Two independent lighting devices 3 each comprises a receiver and transmitter 31 for receiving wireless signals sent from the remote controlling device 2, a first power source 32A electrically connected to the receiver and transmitter 31 and being capable of supplying electricity to four downstream first LED groups 321A connected in series, each first LED group 321A having a plurality of LEDs connected in series, and a second power source 32B electrically connected to the first LED groups 321A and being capable of supplying electricity to four downstream second LED groups 321B connected in series, each second LED group 321 B having a plurality of LEDs connected in series.

Further, an individual may operate the remote controlling device 2 to send wireless signals to the receiver and transmitter 31 of at least one of the lighting devices 3. The receiver and transmitter 31 may execute a command to control both the first LED group 321A via the first power source 32A and the second LED groups 321B via the second power source 32B based on the signals.

The wireless signals are 2G, 3G, 4G, Wifi, Bluetooth, or infrared signals.

The wireless signals contain instructions including light of different wavelengths for different plants, and light of different strengths for different plants. Moreover, strength of light emitted by the first and second LED groups 321A, 321B can be adjusted based on sunlight for saving energy.

While the invention has been described in terms of preferred embodiments, those skilled in the art will recognize that the invention can be practiced with modifications within the spirit and scope of the appended claims.

What is claimed is:

1. A lighting apparatus comprising:
a remote controlling device for sending wireless signals; and
at least one lighting device each including a receiver and transmitter for receiving the wireless signals sent from the remote controlling device, a first power source electrically connected to the receiver and transmitter and being capable of supplying electricity to four downstream first LED groups connected in series, and a second power source electrically connected to the first power source via the first LED groups and being capable of supplying electricity to four downstream second LED groups connected in series;
wherein the receiver and transmitter executes the received wireless signals to control both the first LED group via the first power source and the second LED groups via the second power source based on instructions of the wireless signals.
